(19) United States
(12) Patent Application Publication
(10) Pub. No.: US 2017/0323226 A1
(43) Pub. Date: Nov. 9, 2017

(54) Method for Managing a Network of Napping Pods

(71) Applicant: Mark Karim Zouiyen, New York, NY (US)

(72) Inventor: Mark Karim Zouiyen, New York, NY (US)

(21) Appl. No.: 15/586,097

(22) Filed: May 3, 2017

Related U.S. Application Data
(60) Provisional application No. 62/332,039, filed on May 5, 2016.

(51) Int. Cl. G06Q 10/02; G06F 17/30

(52) U.S. Cl. CPC G06Q 10/02; G06F 17/30864

(57) ABSTRACT

A method for managing a network of napping pods includes a back-end system for storing a napping pod database. A plurality of napping pods is registered with the back-end system, wherein an address is stored for each of the plurality of napping pods. Customers can search for a plurality of available pods from the plurality of napping pods through a software application. The plurality of available pods can be filtered by proximity to the customer, price, rating, and other factors. The customer can then select a specific pod from the plurality of available pods and submit a pod reservation for the specific pod. The back-end system then reserves the specific pod and sends a notification to the owner of the specific pod.

The current application claims a priority to the U.S. Provisional Patent application Ser. No. 62/332,039 filed on May 5, 2016.

### FIELD OF THE INVENTION

The present invention relates generally to rental services. More specifically, the present invention is a system for managing a network of napping pods and placing reservations for customers.

### BACKGROUND OF THE INVENTION

Present day, there is a need in the market for an easily accessible and safe place to rest in the middle of the day. Hotels generally disallow check-in times prior to 3 PM, and users are generally not allowed to book rooms for short stays of time, such as an hour. It is therefore an objective of the present invention to introduce a system that users can utilize to overcome such problems. The industry has a need for places which allow short naps.

The present invention may be applicable to a number of situations. It is a platform for capsule hotels, which can be used anywhere, anytime. The user can book the capsules for an hour, a day, etc. The invention is applicable to youth hostels, airports, offices, restaurants, bus stations, libraries, etc. Fatigued tourists who have been walking around all day may want to pay for a safe place to take a quick nap. Office workers can rest for a few minutes prior to resuming work. The system allows the user to recover and feel rejuvenated after a brief rest period. An entire business can be created around the short nap service, similar in methodology to the office-space-sharing industry.

### BRIEF DESCRIPTION OF THE DRAWINGS

FIG. 1 is a diagram depicting the communication between the back-end system and both the personal user device and the owner device, across a wide area network.

FIG. 2 is a flowchart depicting the steps for reserving a specific pod from a plurality of napping pods.

FIG. 3 is a flowchart thereof, further depicting steps for selecting a plurality of available pods according to the user location.

FIG. 4 is a flowchart thereof, further depicting steps for selecting the plurality of available pods according to vacancy.

FIG. 5 is a flowchart thereof, further depicting steps for selecting the plurality of available pods according to available features.

FIG. 6 is a flowchart thereof, further depicting steps for selecting the plurality of available pods according to rental price.

FIG. 7 is a flowchart thereof, further depicting steps for notifying the owner of the pod reservation.

FIG. 8 is a flowchart thereof, further depicting steps for providing a review of the customer from the owner.

FIG. 9 is a flowchart thereof, further depicting steps for providing a review of the owner from the customer.

### DETAIL DESCRIPTIONS OF THE INVENTION

All illustrations of the drawings are for the purpose of describing selected versions of the present invention and are not intended to limit the scope of the present invention.

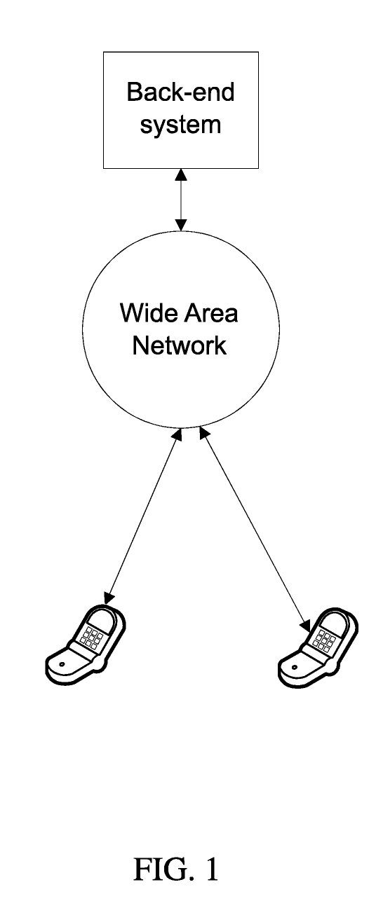

The present invention is a method for managing a network of napping pods. In reference to FIG. 1, a software application is operated across a back-end system and a front-end network. The back-end system includes a server, or a plurality of servers, that host the back-end of the software application. Meanwhile, the front-end network includes a plurality of computing devices through which the front-end of the software application can be accessed by consumers; a consumer being either the owner of a napping pod or an individual seeking to rent a napping pod. The front-end of the software application can be provided as a mobile application or web interface.

The software application is utilized to manage a plurality of napping pods, wherein each of the plurality of napping pods is registered and stored in the back-end system. In the preferred embodiment of the present invention, each of the plurality of napping pods is privately owned. However, the present invention could also be applied to a private network of napping pods, wherein each of the plurality of napping pods is owned by a single entity. Each of the plurality of napping pods is linked to an owner account.

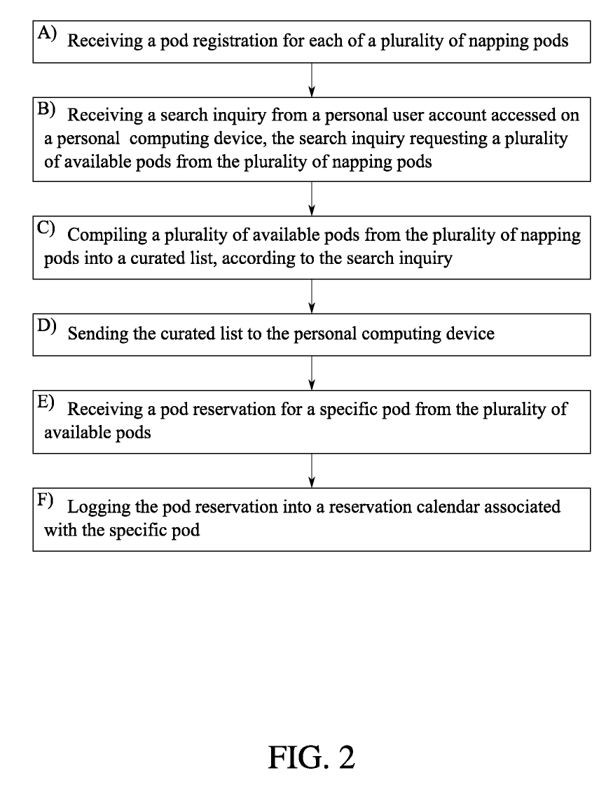

In reference to FIG. 2, a pod registration is received by the back-end system for each of the plurality of napping pods. The pod registration is provided through the owner account associated with each of the plurality of napping pods. In the preferred embodiment of the present invention, the pod registration includes a serial number and an address. The serial number is a unique identifier that is used to link the owner account to an exact pod from the plurality of napping pods. The address for the exact pod is stored in the back-end system, in association with the serial number, and is used to provide a listing of available pods from the plurality of napping pods. The address may be entered manually by a user through the owner account, or the address may be automatically determined using global positioning system (GPS) coordinates retrieved directly from the exact pod.

Once registered, the serial number and the address for each of the plurality of napping pods is stored in a napping pod database on the back-end system. The napping pod database is utilized to locate available napping pods within the vicinity of a customer, or pod renter. When the customer searches for an available pod through the software application, the napping pod database is filtered to find available napping pods in the location designated by the customer.

The owner of the exact pod can manage rental information for the exact pod through the owner account. The rental information may include a rental pricing, a features listing of accommodations offered by the exact pod, the availability of the exact pod (i.e. the days of the week and hours the exact pod is available to be rented), and a description of the exact pod. The rental pricing may be an hourly rate, a daily rate, etc., and may include discounts for booking multiple time slots. The features listing may include the availability of Wi-Fi, the availability of a charger, the availability of a lounge chair, the accessibility of the exact pod, etc.

A customer can download or access the software application on a personal computing device. The customer can create a personal user account in order to reserve one of the plurality of napping pods. In reference to FIG. 2, in order to reserve one of the plurality of napping pods, the customer first submits a search inquiry through the personal user account, wherein the search inquiry requests a plurality of available pods from the plurality of napping pods according to search criteria defined by the customer. The back-end system receives the search inquiry and filters the plurality of available pods from the napping pod database according to the search criteria contained in the search inquiry.

The primary search criteria that is utilized to select the plurality of available pods includes a user location, a pod radius, and a reservation time. The user location can be the current global location of the customer, or a future global location of the user. In the preferred embodiment of the present invention, the user location is determined using geolocation data for the personal computing device. The geolocation data is gathered by the software application from the personal computing device when the customer initiates the search inquiry, wherein the user location is automatically determined. The geolocation data is included in the search inquiry, wherein the back-end system retrieves the geolocation data from the search inquiry and utilizes the geolocation data to select the plurality of available pods from the plurality of napping pods.

In another embodiment, the user location may be entered manually by the customer. This is particularly beneficial if the customer desires to book one of the plurality of available pods in future, as opposed to the present. For example, the customer may be traveling to a different part of town, or to a different town altogether, and want to reserve one of the plurality of available pods such that the customer can use it upon arrival.

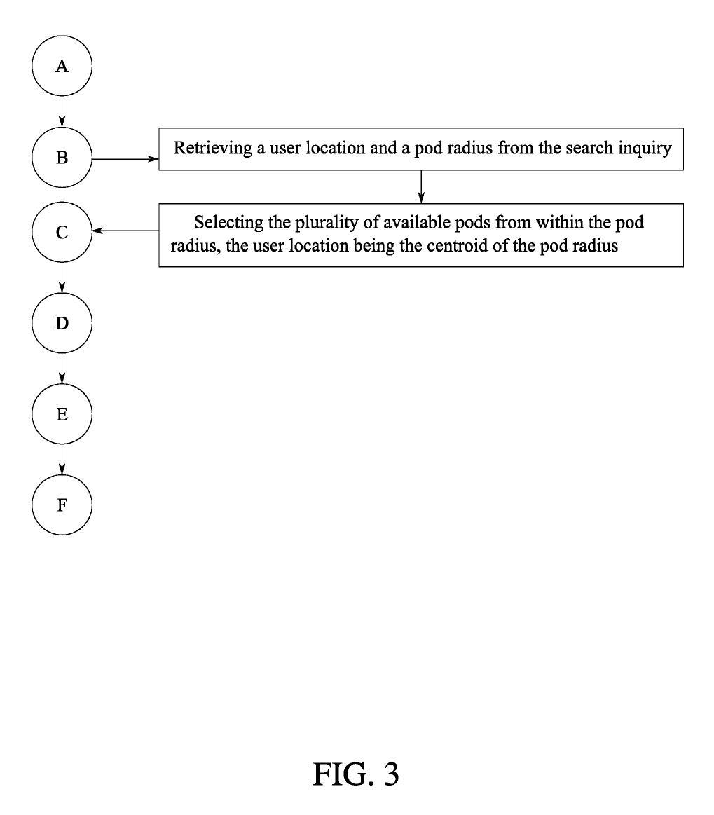

The pod radius is utilized to limit the number of results obtained by the back-end system when searching for the plurality of available pods. The pod radius sets a perimeter around the user location, defining how far the customer is willing to travel in order to utilize one of the plurality of napping pods. In reference to FIG. 3, the pod radius is submitted with the search inquiry, wherein the back-end system retrieves the pod radius from the search inquiry. The back-end system then utilizes the pod radius in conjunction with the user location to select only the plurality of available pods from within the pod radius.

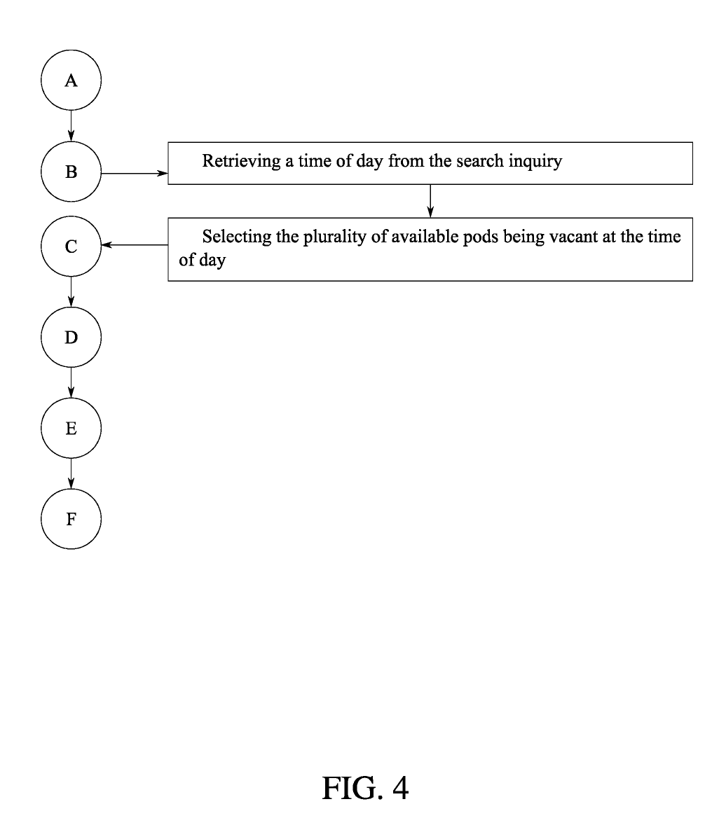

The reservation time includes the date and time that the customer would like to rent one of the plurality of napping pods. By default, the initial date selected is the current day. However, the customer can change the date in order to reserve a napping pod days in advance, weeks in advance, months in advance, etc. Similarly, the default time selected is the current time, however, the customer can enter a later time if desired. In reference to FIG. 4, the reservation time is submitted with the search inquiry, wherein the back-end system retrieves the reservation time from the search inquiry. The back-end system then utilizes the reservation time to select the plurality of available pods being vacant for the reservation time.

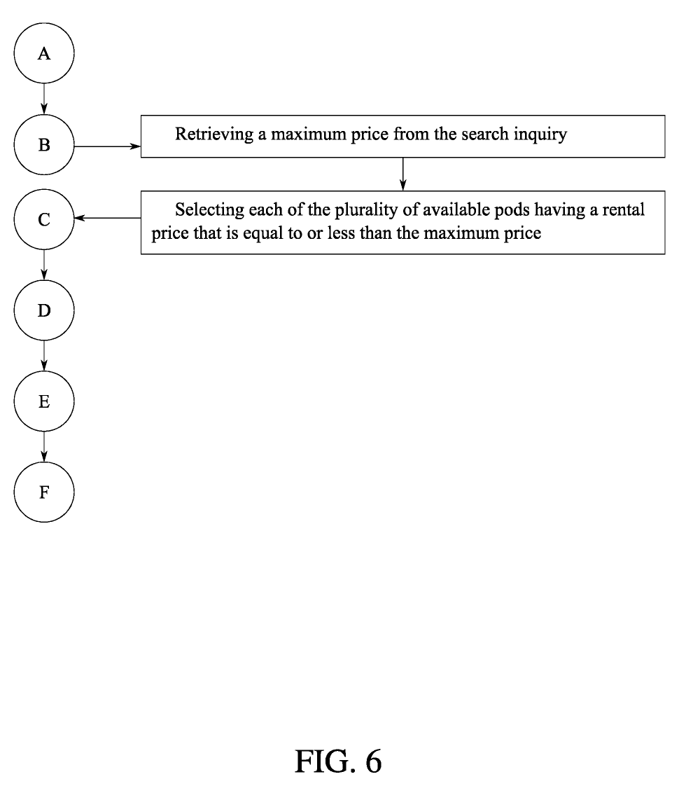

The search criteria may further include a maximum price or at least one pod feature. The maximum price is the highest rate that the customer is willing to pay in order to rent one of the plurality of napping pods. The maximum price could be a total reservation amount, an hourly rate, etc. In reference to FIG. 6, the maximum price is submitted with the search inquiry, wherein the back-end system retrieves the maximum price from the search inquiry. The back-end system then utilizes the maximum price to select the plurality of available pods having a rental price that is equal to or less than the maximum price.

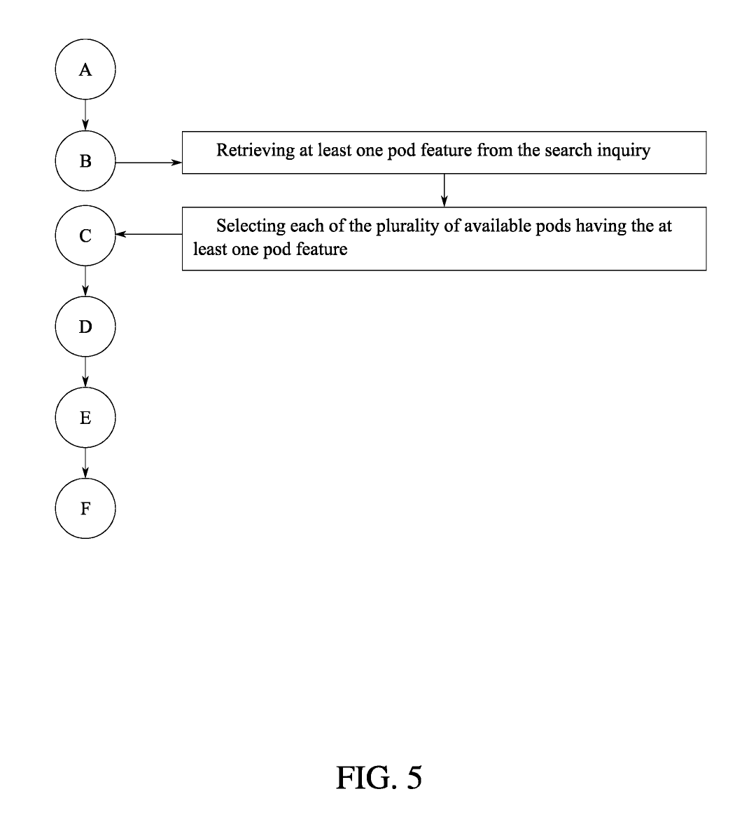

The at least one feature includes one or more amenities desired by the customer. The at least one feature may include, but is not limited to, Wi-Fi availability, a charger, a lounge chair, a fold-down tray, a specific number of storage compartments, etc. In reference to FIG. 5, the at least one feature is submitted with the search inquiry, wherein the back-end system retrieves the at least one feature from the search inquiry. The back-end system then selects the plurality of available pods having the at least one feature available to the customer.

In reference to FIG. 2, once the back-end system has selected the plurality of available pods according to the search criteria within the search inquiry, the back-end system compiles the plurality of available pods into a curated list. The curated list is then shared with the personal user account, wherein the customer can select one of the plurality of available pods to reserve. More specifically, the curated list is sent to the personal computing device, wherein the customer can view the curated list through the personal user account.

In the preferred embodiment of the present invention, the plurality of available pods is ordered within the curated list from closest proximity to the personal computing device to furthest proximity to the personal computing device. This is performed for the convenience of the customer, as to limit the amount of travel necessary. However, it is also possible for the plurality of available pods to be listed according to different parameters. For example, the customer may be able to sort the plurality of available pods according to an owner rating, or from least expensive to most expensive.

In reference to FIG. 2, the customer can select a specific pod from the plurality of available pods through the personal user account, in order to make a pod reservation. The pod reservation includes a reservation date, a start time, and a reservation duration. The reservation date and the start time may be automatically populated using the information previously entered for the reservation time, or the user may manually enter the reservation date and the start time. The pod reservation is submitted to the back-end system, wherein the back-end system receives the pod reservation and confirms that the specific pod is available.

The back-end system verifies the availability of the specific pod by comparing the reservation date, the start time, and the reservation duration to a reservation calendar for the specific pod. The reservation calendar is used to schedule rental times for the specific pod, and can be viewed through the owner account. If the reservation date, the start time, and the reservation duration are verified to be available, then the back-end system logs the pod reservation into the reservation calendar. This prevents any other reservations from being made throughout the reservation duration. If the reservation date, the start time, or the reservation duration is verified as unavailable, then the back-end system prompts the personal user account to enter a new date, time, or duration.

Upon making the pod reservation, the customer is prompted to provide payment through the personal user account. The total payment due is calculated by the back-end system based on the rental pricing set by the owner and the reservation duration set by the customer. A commission from the host of the back-end system and the software application may also be included in the total payment due. The customer can use payment details stored in the personal user account or enter payment information in order to electronically pay for the rental of the specific pod.

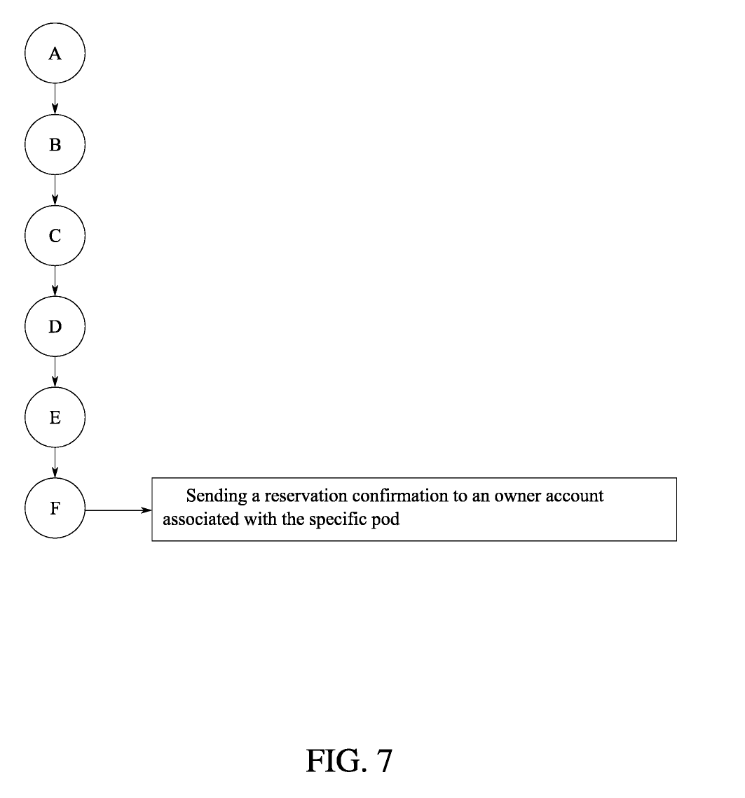

In reference to FIG. 7, once the pod reservation has been accepted by the back-end system and scheduled into the reservation calendar for the specific pod, the back-end system sends a reservation confirmation to the owner account associated with the specific pod. The reservation confirmation may also be sent to the owner via short message service, email, or any other suitable means of communication. The owner can also view the reservation calendar for the specific pod through the owner account in order to verify and monitor usage of the specific pod.

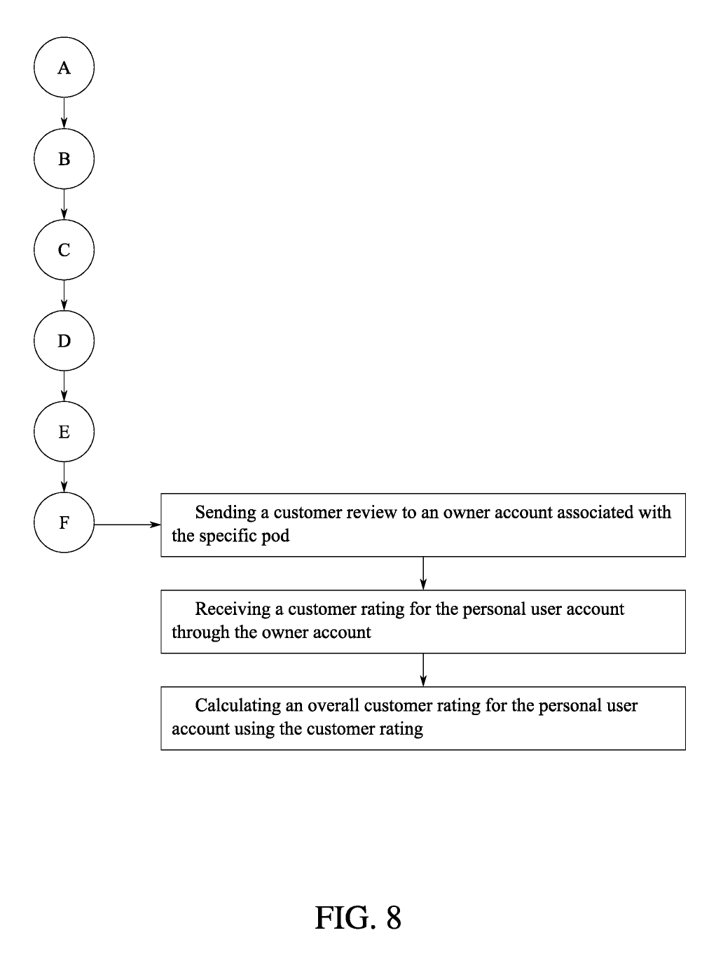

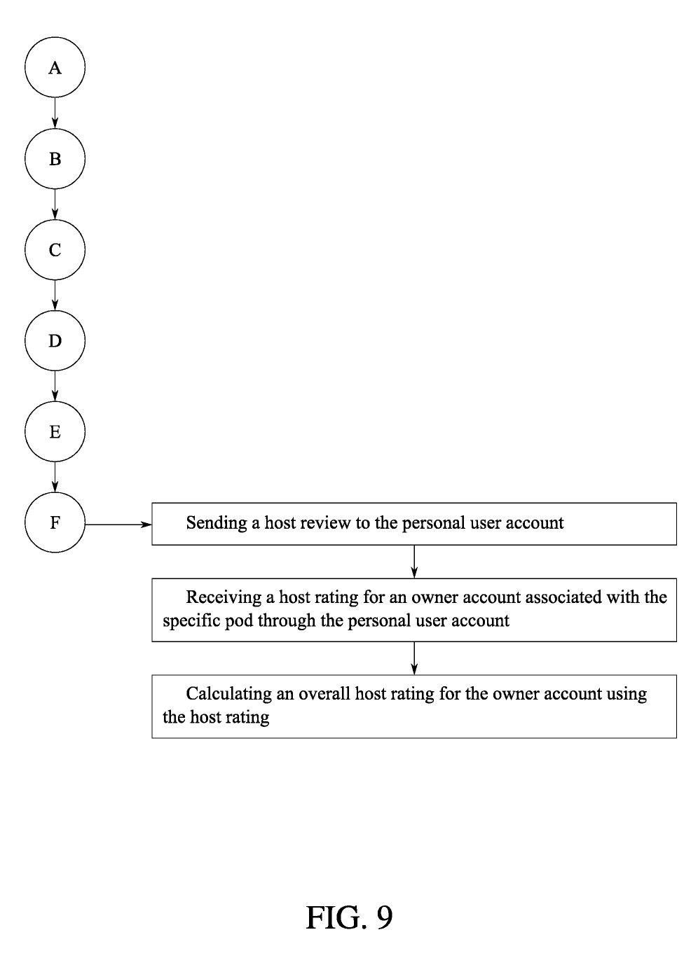

In reference to FIG. 8-9, once the reservation duration has expired, the owner and the customer are able to provide ratings for each other based on their experience. The back-end system sends a customer review to the owner account and a host review to the personal user account. The customer review may ask the owner to rate the cleanliness of the customer, the attitude of the customer, the overall experience with the customer, or any other desired traits. The owner answers the customer review by submitting a customer rating for the personal user account, and in turn the customer. The back-end system receives the customer rating through the owner account and calculates an overall customer rating for the personal user account using the customer rating; the overall customer rating being a culmination of all previous ratings.

Similar to the customer review, the host review may ask the customer to rate the cleanliness of the specific pod, the attitude of the host, the overall experience with the host and the specific pod, or any other desired traits. The customer answers the host review by submitting a host rating for the owner account, and in turn the owner of the specific pod. The back-end system receives the host rating through the personal user account and calculates an overall host rating for the owner account using the host rating; the overall host rating being a culmination of all previous ratings.

The present invention allows for the use of a variety of different napping pods. The following describes features that may be found throughout different embodiments of the napping pods.

In one embodiment, a napping pod is in the form of a rectangular prism with rounded corners. The napping pod has a flat bottom and top, such that napping pods can be stacked one on top of another. In another embodiment, each of the napping pods is a hexagonal prism, wherein the napping pods can be stacked in a honeycomb fashion. It is important to note that other embodiments may have more stacking configurations other than the ones specified in this disclosure. Many other different shapes can be utilized for the profile of the napping pods in other embodiments. The location of the napping pods or the aesthetics of the room in which the napping pod is placed may also be a factor in the design of the profile of the napping pod.

In one embodiment, each of the napping pods has a sliding door for accessing the pod. The sliding door allows the user to open and close the sleeping chamber without having the door protrude in a way that is intrusive to other users nearby. In another embodiment, each of the napping pods has a hinged door, wherein the hinged door opens outwards, away from the pod.

In some embodiments, each of the napping pods may include a one or more storage compartments. The storage compartments may be accessible from the interior or exterior of the napping pod. If the storage compartments are externally accessible, then each of the storage compartments may include a lock for securing the storage compartment closed and preventing theft. The lock may be any type of industry-standard lock, including padlock, combination, keycard, etc. Alternative or future embodiments of the invention may include other types of locks not explicitly included here.

In embodiments featuring stacked napping pods, one or more stairs may be included for accessing the upper pods. In one embodiment, the stairs is formed by a series of foot/hand slots on a flat surface. In some embodiments, the stairs may be moveable along a track that extends along the length of the napping pod. This allows the stairs to be moved out of the way when not in use, or to be moved to an adjacent napping pod.

A wall anchor may be used in some embodiments to secure the napping pod against a wall; this is particularly beneficial when stacking the napping pods. The wall anchor is a locking mechanism designed to affix the capsule to the wall, for the purpose of additional security. It is an industry-standard locking mechanism or clamp; it may be a bolt or other type of affixing mechanism. In some embodiments, there may be more than one wall anchor; this allows both ends of a napping pod to be secured to the wall.

In some embodiments a lounge chair may be included with the napping pod. The lounge chair provides a second resting option in addition to the standard resting surface provided by the napping pod (i.e. a bed/mattress). The lounge chair may have reclining features. Notably, the lounge chair may be removable from the napping pod and is an optional component.

Each of the napping pods may include an anti-microbial mattress cover that covers the mattress within the napping pod. The anti-microbial mattress cover comprises a washable anti-microbial fabric that is resistant to bacteria. The anti-microbial mattress cover may use the same type of fabric utilized in medical scrubs and other similar products, that are prone to retaining bacteria.

In some embodiments, each of the napping pods may include an anti-microbial spray system. The anti-microbial spray system is arranged within the interior of the napping pod and is utilized to disinfect and keep the interior environment of the napping pod clean in between uses. The anti-microbial spray system may include a plurality of nozzles or other spray dispensers located at medically-optimal locations within the interior of the napping pod.

A user-detection system may also be used in conjunction with the anti-microbial spray system. such as ultrasonic or other sensors.

The user-detection system includes sensors that are able to detect the presence of an individual within the napping pod. When the user-detection system detects that the individual has exited the napping pod, then the user-detection system activates the anti-microbial spray system, such that the spray dispensers will automatically spray the interior of the napping pod.

In some embodiments, a fold-down tray may be integrated into the interior of the napping pod. The fold-down tray may be similar to those utilized on airline seats. The fold-down tray provides a flat surface for the user to place objects on while resting in the napping pod, such as a cellphone. In some embodiments, the tray may be detachable and removable from within the napping pod.

In some embodiments, each of the napping pods may include a geolocator system. The geolocator system includes a global positioning system (GPS) geolocator mounted into the capsule. The GPS geolocator is utilized to locate the napping pod when the customer performs the search inquiry for the plurality of napping pods.

In some embodiments, the napping pod may include a solar panel system. The solar panel system includes one or more solar panels. The one or more solar panels is positioned about the exterior of the napping pod, wherein the one or more solar panels is positioned to absorb solar light. The solar panel system is utilized to provide power to all or some of the electronics systems of the napping pods.

Some of the napping pods may include a docking/charging cradle. The docking/charging cradle is installed within the interior of the napping pod and allows the user to charge an electronic device such as a phone, tablet, etc. The docking/charging cradle may be powered by the solar panel system, or another supplementary power source.

Although the invention has been explained in relation to its preferred embodiment, it is to be understood that many other possible modifications and variations can be made without departing from the spirit and scope of the invention as hereinafter claimed.

What is claimed is:

1. A method for managing a network of napping pods, the method comprises the steps of:
receiving a pod registration for each of a plurality of napping pods;
receiving a search inquiry from a personal user account accessed on a personal computing device, the search inquiry requesting a plurality of available pods from the plurality of napping pods;
compiling a plurality of available pods from the plurality of napping pods into a curated list, according to the search inquiry;
sending the curated list to the personal computing device;
receiving a pod reservation for a specific pod from the plurality of available pods; and
logging the pod reservation into a reservation calendar associated with the specific pod.

2. The method for managing a network of napping pods, the method as claimed in claim 1 further comprises the steps of:
retrieving a user location from the search inquiry; and
selecting the plurality of available pods according to the user location.

3. The method for managing a network of napping pods, the method as claimed in claim 2 further comprises the steps of:
retrieving a pod radius from the search inquiry; and
selecting the plurality of available pods from within the pod radius, the user location being the centroid of the pod radius.

4. The method for managing a network of napping pods, the method as claimed in claim 2, wherein the plurality of available pods is ordered within the curated list from closest proximity to the personal computing device to furthest proximity to the personal computing device.

5. The method for managing a network of napping pods, the method as claimed in claim 2, wherein the user location is determined by geolocation data for the personal computing device.

6. The method for managing a network of napping pods, the method as claimed in claim 1 further comprises the steps of:
retrieving a reservation time from the search inquiry; and
selecting the plurality of available pods being vacant for the reservation time.

7. The method for managing a network of napping pods, the method as claimed in claim 1 further comprises the steps of:
retrieving at least one pod feature from the search inquiry; and
selecting each of the plurality of available pods having the at least one pod feature.

8. The method for managing a network of napping pods, the method as claimed in claim 1 further comprises the steps of:
retrieving a maximum price from the search inquiry; and
selecting each of the plurality of available pods having a rental price that is equal to or less than the maximum price.

9. The method for managing a network of napping pods, the method as claimed in claim 1, wherein the pod registration of each of the plurality of napping pods includes an address.

10. The method for managing a network of napping pods, the method as claimed in claim 1, wherein the pod reservation includes a reservation date, a start time, and a reservation duration.

11. The method for managing a network of napping pods, the method as claimed in claim 1 further comprises the step of:
sending a reservation confirmation to an owner account associated with the specific pod.

12. The method for managing a network of napping pods, the method as claimed in claim 1 further comprises the steps of:
sending a customer review to an owner account associated with the specific pod; and
receiving a customer rating for the personal user account through the owner account.

13. The method for managing a network of napping pods, the method as claimed in claim 12 further comprises the step of:
calculating an overall customer rating for the personal user account using the customer rating.

14. The method for managing a network of napping pods, the method as claimed in claim 1 further comprises the steps of:
sending a host review to the personal user account; and
receiving a host rating for an owner account associated with the specific pod through the personal user account.

15. The method for managing a network of napping pods, the method as claimed in claim 14 further comprises the step of:
calculating an overall host rating for the owner account using the host rating.
